(19) United States
(12) Patent Application Publication
(10) Pub. No.: US 2020/0094086 A1
(43) Pub. Date: Mar. 26, 2020

(54) Safety Cable Routing System

(71) Applicant: PerfectVision Manufacturing, Inc., Little Rock, AR (US)

(72) Inventors: Scott Stekr, Littleton, CO (US); Douglas Salvatori, Minooka, IL (US); Brenton Barton, Golden, CO (US); Dominic Newnham, Centennial, CO (US)

(73) Assignee: PerfectVision Manufacturing, Inc., Little Rock, AR (US)

(21) Appl. No.: 16/137,303

(22) Filed: Sep. 20, 2018

(51) Int. Cl. A62B 35/00; F16M 13/02

(52) U.S. Cl. CPC A62B 35/0068; A62B 35/005; F16M 13/022

(57) ABSTRACT

A system designed for managing safety cables utilized by technicians working on wireless communication structures. The system is designed to properly secure and route a structure's safety cable such that it does not become entangled with the appurtenances installed on the structure or damage any installed appurtenance. This system is designed to prevent the climbing facility from becoming obstructed while maintaining the integrity of the fall arrest cable system and protection of the technician from a potential hazard. The system is secured to the tower or existing and future appurtenances via brackets and clamps and is adaptable to varying types of structures and appurtenances.

### FIELD OF THE INVENTION

The present invention relates generally to mounts or brackets for wireless communication towers. More particularly, the present invention relates to mounts and brackets which facilitate the secure routing of fall arrest cables which are used by tower technicians

### BACKGROUND OF THE INVENTION

Wireless data and voice communications services have become ubiquitous in modern society. In order to transmit the signals necessary to facilitate these services, there is a need for antennas and radios to both transmit and receive the wireless signals. This transmission equipment must be situated high above the ground on a structure and properly positioned in order to optimize signal transmission. Additionally, because of the increasing utilization of wireless communications, the number of radios and equipment per tower is increasing, as are the size of the antennas being mounted.

With the increasing amount of equipment being mounted on the structures, there is a greater need for technicians to work on the towers or the antennas and other appurtenances mounted thereto. Due to the nature of wireless communication towers, there is an inherent risk in the installation and maintenance of the antennas and mounts as they are typically located high above the ground. It is customary for technicians to employ the use of personal safety equipment including fall arrest cables which attach to the technician as well as the tower. The climbing facility in which the cable is located often become obstructed because the appurtenances are mounted to create 360 degree coverage, attaching to all sides of the structure. In certain cases, the climbing cable is deemed a hazard above specific locations due to appurtenances. Accordingly, it is desirable to provide a system which allows for the cable to pass safely and securely past, though, or around the obstruction caused by the appurtenance, allowing for the competent person (technician) to ascend past the obstruction while keeping the cable secure and free from damage caused by the appurtenance.

### SUMMARY OF THE INVENTION

The present invention is a system for routing and securing fall arrest cables to appurtenances on wireless communication structures to maintain the integrity of the fall protection cable. The system consists of a mounting assembly which attached to the tower or a mounted component and a cable guide which attaches to the mounting assembly and removably secures the fall arrest cable which is utilized by tower technicians as personal safety equipment in such a way that the cable will not become entangled with the equipment mounted to the tower.

The object of the present invention is to provide a system to route and secure fall arrest safety cables to a wireless communication tower such that the cable does not become damaged when obstructed with equipment mounted to a wireless communication tower and pose a risk to the tower technician as well as to the integrity of the fall arrest cable system.

It is a further object of this invention to provide a system of cable routing which may be secured to multiple types of tower structures or equipment mounting hardware.

It is a further object of this invention to provide a system of cable routing which is adjustable to multiple positions and which may be adjusted after the bracket is firmly secured to the tower structure.

It is a further object of this invention to provide system of cable routing which is simple to manufacture and simple to assemble in the field by the installer.

The advantages of the present invention include that it is adaptable to many shapes and sizes of tower structure and component mounting assemblies, imparts less stress on tower components, is simple to manufacture and assemble, and provides a higher level of safety for tower technicians by maintaining the integrity of the fall arrest cable system.

These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is an isometric view of the mounting clamp assembly of a first embodiment of the present invention;

FIG. 2 is a second isometric view of the mounting clamp assembly of a first embodiment of the present invention;

FIG. 3 is a side view of the mounting clamp assembly of a first embodiment of the present invention;

FIG. 4 is a top view of the mounting clamp assembly of a first embodiment of the present invention;

FIG. 5 is an end view of the mounting clamp assembly of a first embodiment of the present invention;

FIG. 6 is an isometric view of a first embodiment of the present invention;

FIG. 7 is an isometric view of a first embodiment of the present invention as mounted for use;

FIG. 8 is an isometric view of a first embodiment of the present invention as mounted for use;

FIG. 9 is an isometric view of the mounting clamp assembly of a second embodiment of the present invention;

FIG. 10 is a side view of the mounting clamp assembly of a second embodiment of the present invention;

FIG. 11 is a top view of the mounting clamp assembly of a second embodiment of the present invention;

FIG. 12 is an end view of the mounting clamp assembly of a second embodiment of the present invention;

FIG. 13 is an isometric view of a second embodiment of the present invention;

FIG. 14 is a side view of a second embodiment of the present invention;

FIG. 15 is an isometric view of a second embodiment of the present invention as mounted for use;

FIG. 16 is an isometric view of the bracket assembly of a third embodiment of the present invention;

FIG. 17 is an isometric view of a third embodiment of the present invention as mounted for use;

FIG. 18 is an isometric view of the bracket assembly of a fourth embodiment of the present invention;

FIG. 19 is an isometric view of a fourth embodiment of the present invention as mounted for use;

FIG. 20 is an isometric view of the bracket assembly of a fourth embodiment of the present invention;

FIG. 21 is an isometric view of a fourth embodiment of the present invention as mounted for use;

### DETAILED DESCRIPTION OF THE PREFERRED EMBODIMENTS

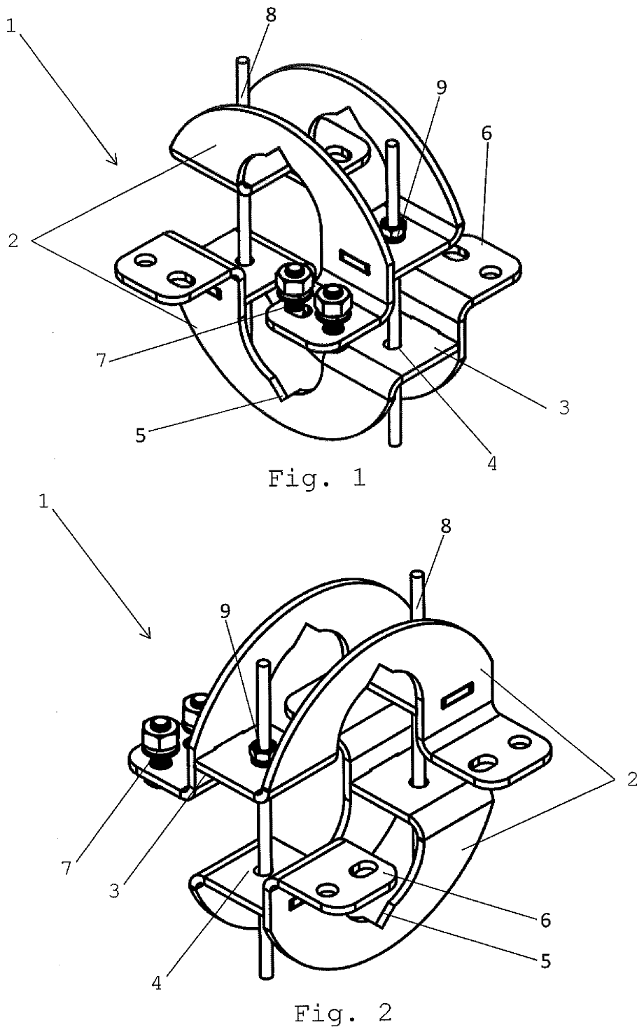

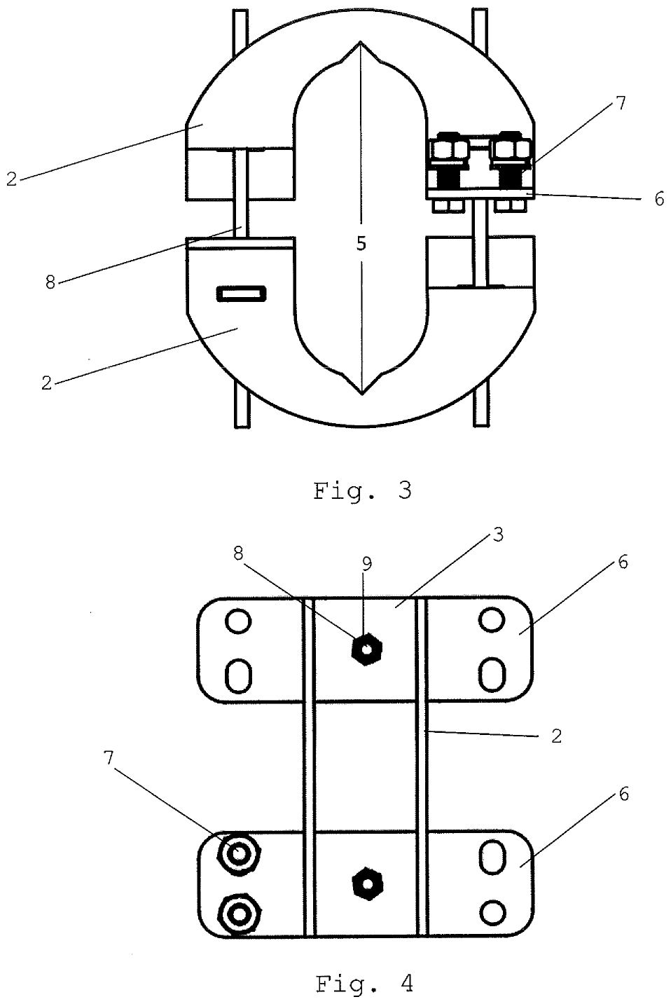

Referring to the drawings, FIGS. 1-6 depict a first embodiment of a safety cable routing system featuring a clamp assembly 1 which comprises two clamp members 2, a plurality of clamping rods 8 with clamping collars 9, and a cable guide 10.

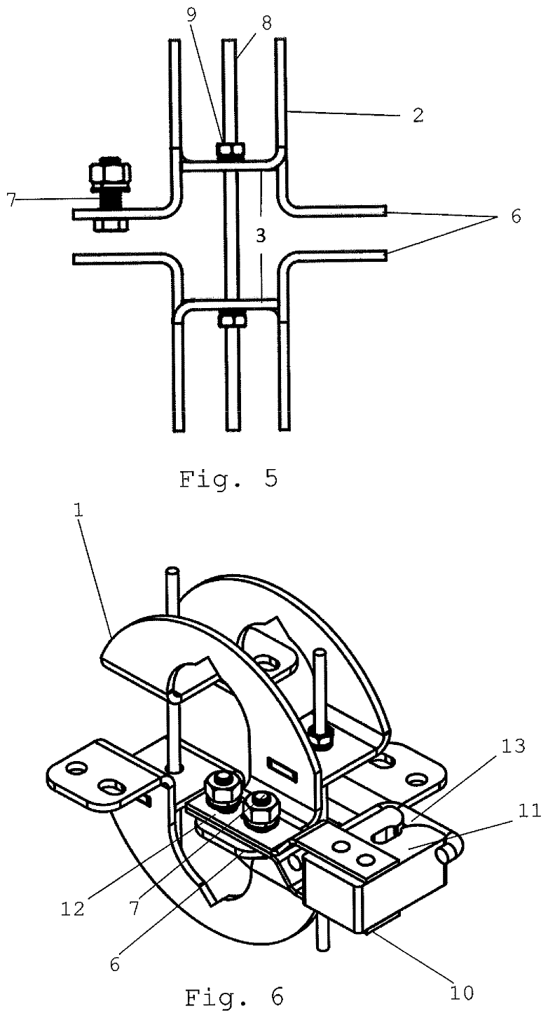

The clamp members 2 preferably have a U shape when viewed from the end as depicted in FIG. 5. At the center of the U on each end of the clamp member 2, there are center sections 3 which are preferably flat and contain one or more holes 4 on each center section. The clamp member 2 preferably has two center sections 3 per assembly. The members 2 may also have a seating notch 5. When viewed from the side as depicted in FIG. 3, the clamp members preferably have a rounded U shape configured to partially surround the member to which the clamp assembly is to be mounted. The seating notch 5 is located at the bottom of the valley of the clamp member's 2 U shape (or at the peak if the clamp member is oriented upside down). The seating notch is preferably a V notch, but may use other arrangements as well. The clamp members may consist of a single, unitary piece or may consist of multiple pieces affixed together.

The clamp members 2 may also have one or more mounting tabs 6. The mounting tabs 6 may extend below and to the side of the clamp member 2 and are preferably parallel to the plane of the center section 3. The mounting tabs 6 are preferably offset vertically from the plane of the center section 3, but the mounting tabs 6 may be coplanar with the center section 3. The mounting tabs may also have a plurality of holes. The clamp members 2 preferably have two mounting tabs each which are preferably oriented on diagonally opposing corners. However, the mounting clamps 2 may have more than two mounting tabs. The clamp assembly may also have one or more mounting fasteners 7 which may be attached to the mounting tabs 6. Bolts with nuts are the preferred mounting fastener 7, but other fasteners known in the art may also be utilized.

The clamp assembly 1 may also feature a plurality of clamp rods 8 and clamp collars 9. The clamp rods 8 are configured such that they will fit through the holes 4 of the center section 3 of the clamp member. The clamp rod 8 is preferably a bolt or threaded rod. The clamp collar 9 is configured such that it will not pass through the holes 4 of the center section 3. The clamp collar 9 is preferably a threaded nut which will engage with the clamp rod 8. However, the clamp collar 9 may also engage the clamp rod 8 via friction, permanent attachment, or other means of engagement known in the art.

The clamp assembly 1 and its components are preferably made of metal unless specifically stated otherwise herein. Though, it may be made of other rigid materials.

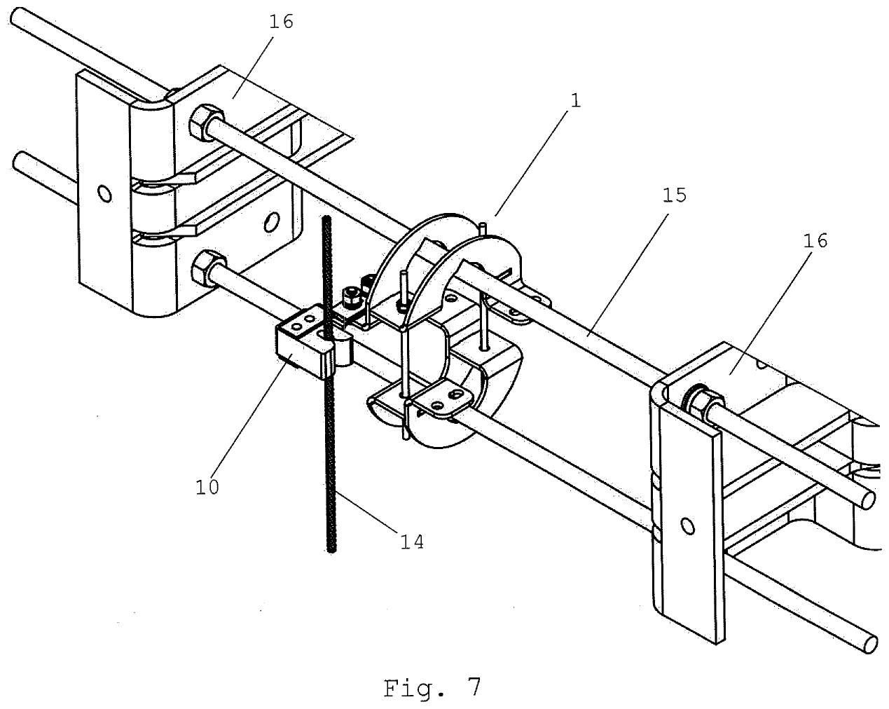

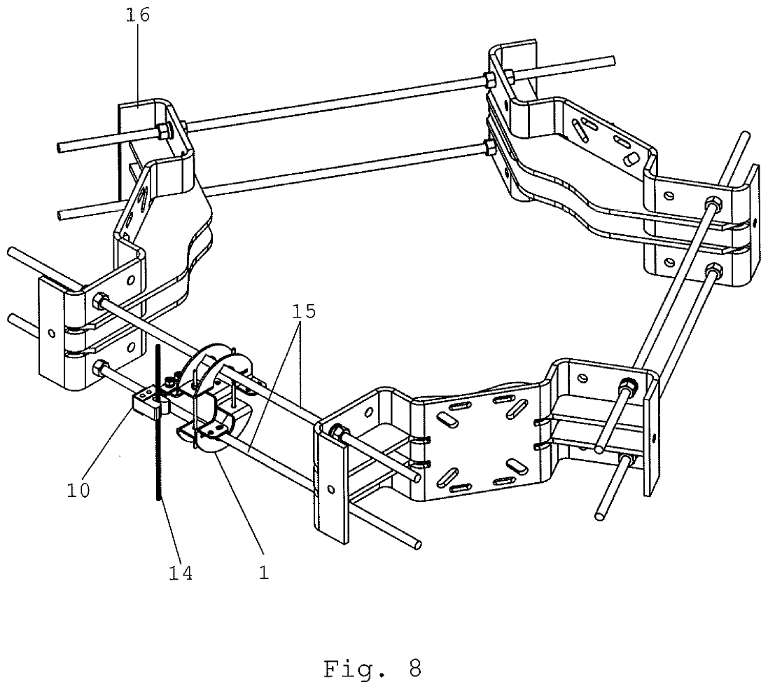

Referring to the drawings, FIGS. 6-8, the first embodiment further consists of a cable guide 10. The cable guide 10 comprises a plurality of semi rigid prongs 11 and a bracket 12. The prongs are preferably made from semi rigid rubber or foam and are configured such that once inserted between the prongs 11, a safety cable 14 will be firmly held but may be removed when the cable 14 it deliberately pulled from the prongs 11. The bracket 12, is preferable made of metal or other rigid material and is affixed to the prongs 11. The bracket 12 is also configured such that it may be affixed to a mounting tab 6 of a clamp member 2. The cable guide 10 may also consist of a lock 13 which is movably affixed to the prongs 11 and is configured to be positioned adjacent to the opening of the two prongs such that a cable inserted in between the prongs will be physically blocked by the lock from being removed from the prongs 11 as depicted in FIG. 6. The lock is preferably configured in a squared J shape and configured such that the lock wraps around the front of the prongs and it rotatable about the axis formed by the straight shank of the J such that it may be moved out of the way of the prongs 11 such that a cable 14 may be inserted or removed. The cable guide 10 is configured such that it may be mounted to any mounting tab 6 and such that multiple cable guides 10 may be mounted to a single clamp assembly 1.

Referring to the drawings, FIGS. 6-8 depict the clamp assembly 1 assembled and attached to a communication tower. The clamp assembly 1 is preferably configured to be secured to two parallel components 15 of a communication tower or equipment mount 16 affixed to a tower. To use the clamp assembly 1, a clamp member 2 is placed on each of the components to which the assembly is to be mounted and oriented such that the central section of the members' U shapes are oriented to face each other and the clamp holes 4 are aligned. Clamping rods 8 are inserted through the clamp holes 4 of each clamp member such that each clamp rod 8 is placed through the clamp holes 4 of both clamp members 2. Clamping collars 9 are then attached to the clamp rods 8 and tightened such that the clamp assembly 1 is secured to the members to which the assembly is mounted. The assembly 1 may also be attached to a single member of a tower or mount in the same manner with the only difference being that the two clamp members 2 shall be placed on opposing sides of the single member as opposed to each being placed on different members.

One or more cable guides 10 may be attached to the mounting tabs 6 of the assembly 1 by affixing the bracket 12 to the tabs 6 via one or more mounting fasteners 7. The cable guide(s) 10 may be attached to the mounting tabs before or after the assembly 1 is mounted to the tower. Once the assembly is mounted to the tower, a safety cable 14 may be inserted into the prongs 11 of the cable guide 10 and may be secured by the lock 13 to ensure retention of the cable 14 by the cable guide 10. It may be desirable to install multiple assemblies to a single tower in various configurations.

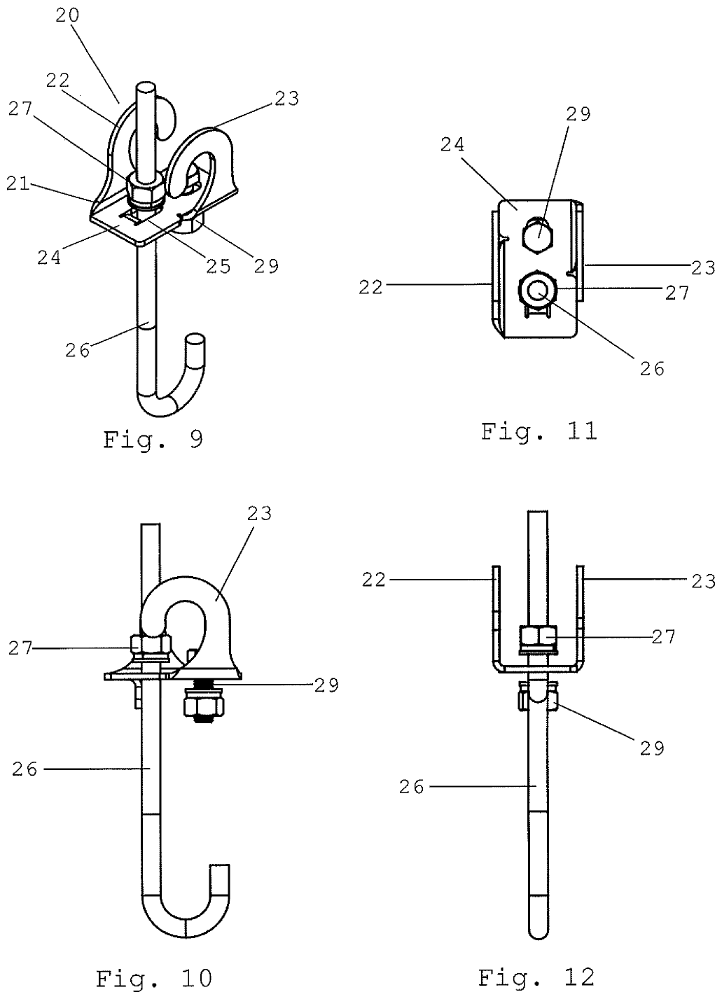

Referring to the drawings, FIGS. 9-15 depict a second embodiment of a safety cable routing system featuring a clamp assembly 20 which comprises a head piece 21, a tail piece 26 with tail collar 27, and a cable guide 10 secured to the head piece 21.

The head piece 21 preferably has a U shape when viewed from the end as depicted in FIG. 12. The uprights of the U shape comprise a first hook 22 and second hook 23 oriented on opposite sides of the head piece 21. The first hook 22 and second hook 23 should be congruent in shape and be shaped such that there is an opening. The first and second hooks 22, 23 are preferably oriented such that the openings of each respective hook should be oriented in opposite directions as depicted in FIGS. 9, 13, 14, and 15. Further, the hooks are preferably oriented such that the open section of the first hook 22 is aligned with the open section of the second hook 23 such that a single member may pass through both. At the center of the U on the head piece 21 is a center section 24 which is preferably flat. The center section additionally has a clamp hole 25 and may also have a mounting hole 28. The head piece 21 may consist of a single, unitary piece or may consist of multiple pieces affixed together.

The clamp assembly 20 also consists of a tail piece 26. The tail piece is configured into a J shape with a bend at the bottom and a straight shank comprising upper portion. The shank is preferably be threaded. The tail piece 26 is configured such that it may pass through the clamp hole 25 of the head piece 21. The tail piece 26 is configured to attach to the head piece 21 via the tail collar. The tail collar 27 should be sized such that it will not pass through the clamp hole 25. The tail collar 27 is preferably a nut which corresponds in size and threading to the preferably threaded shank of the tail piece 26, however the tail collar 27 may also engage the tail piece 26 via friction, permanent attachment or other means of engagement known in the art.

The clamp assembly 20 and its components are preferably made of metal unless specifically stated otherwise herein, though may be made of other rigid material.

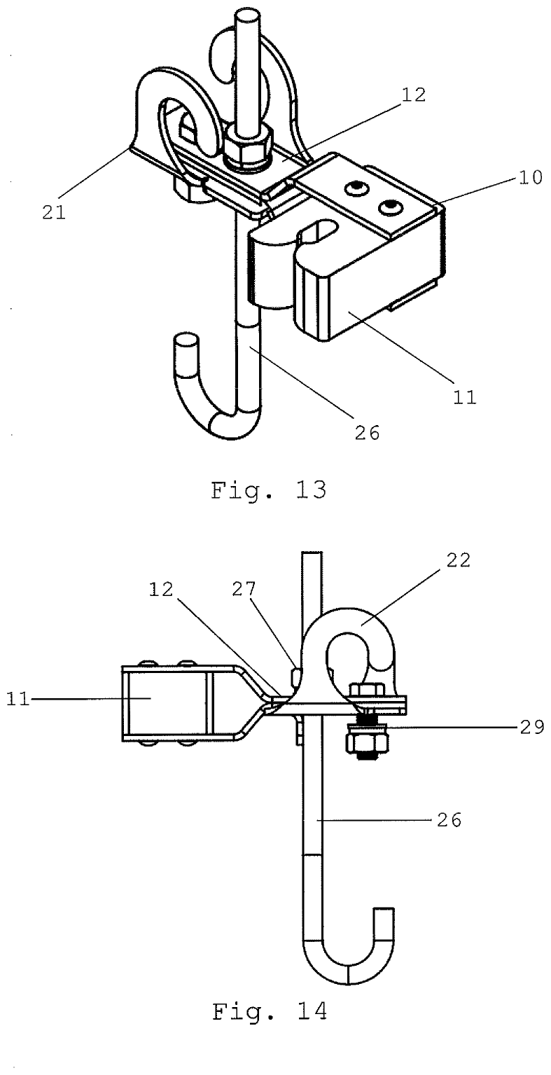

Referring to the drawings FIGS. 13-15, the clamp assembly 20 further consists of a cable guide 10 which may be attached to the clamping assembly 20. The cable guide 10 may be attached to the center section 24 of the head piece 21. Preferably, the bracket 12 of the cable guide will have holes bearing the same configuration of the clamping hole 25 and mounting hole 28 of the headpiece. In the preferred configuration, the holes on the bracket 12 would be aligned with the holes 25, 28 of the head piece and a mounting fastener 29 would be utilized to attach one of the bracket holes to the mounting hole 28. Bolts with nuts are the preferred mounting fastener 29, but other fasteners known in the art may also be utilized. Further in the preferred configuration, the shank of the tail piece 26 would be inserted through the clamp hole 25 of the head piece 21 as well as an unoccupied hole of the cable guide bracket 12 and the tail collar 27 placed on the tail piece shank above the bracket 12. Alternatively, the cable guide may be attached via a single hole in the bracket 12 attached to either the clamp hole 25 and the tail piece 26 and tail collar 27 or to the mount hole 28 and mount fastener 29.

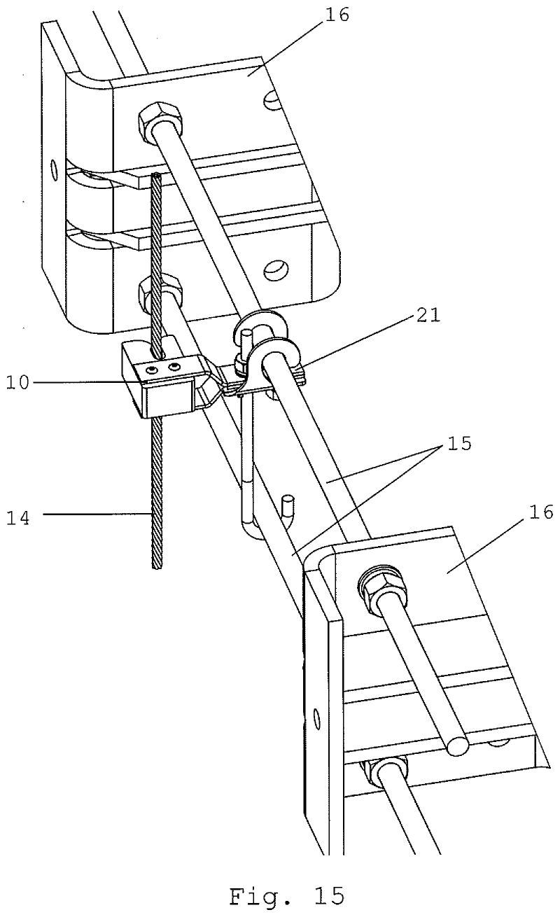

Referring to the drawings, FIG. 15 depicts the clamp assembly 20 assembled and attached to a communication tower. The clamp assembly 20 is preferably configured to be secured to two parallel components 15 of a communication tower or equipment mount 16 affixed to a tower. To use the clamp assembly 20, the head piece 21 is placed on one of the components 15 such that both the first hook 22 and second hook 23 are in contact with the component 15. The shank of the tail piece is then inserted through the clamp hole 25 and the curve of the tail piece is placed such that it in in firm contact with the other component 15 as depicted in FIG. 15. The tail collar 25 is then attached to the tail piece and configured such that the head and tail piece are firmly in contact with the components 15. The assembly 1, may also be attached to a single member of a tower or mount in the same manner with the only difference being that the head piece 21 and tail piece 26 shall be placed on opposing sides of the single member as opposed to each being placed on different members. The cable guide may be attached to the clamp assembly as described hereinabove.

Once the assembly is mounted to the tower, a safety cable 14 may be inserted into the prongs 11 of the cable guide and may be secured by the lock 13 to ensure retention of the cable 14 by the cable guide 10. It may be desirable to install multiple assemblies to a single tower in various configurations.

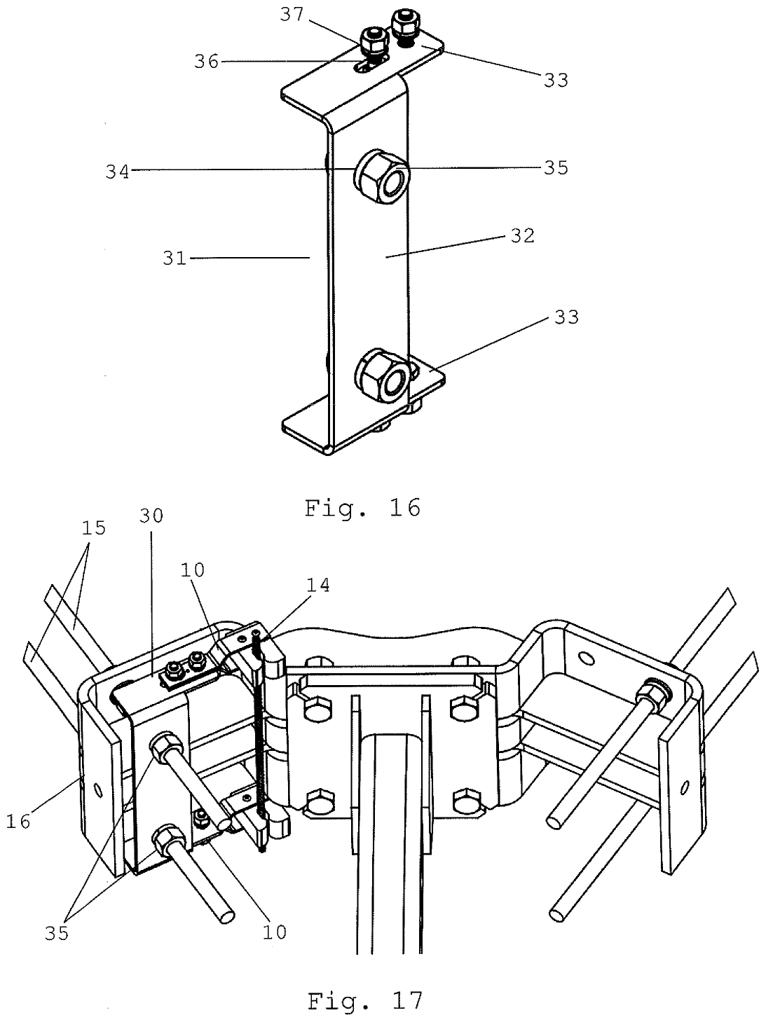

Referring to the drawings, FIGS. 16-17 depict a third embodiment of a safety cable routing system 30 featuring a mounting bracket 31 which comprises a central section 32, a plurality of mounting tabs 33, attachment collars 35, and mounting fasteners 37.

The bracket 31 is configured to attach to a communication tower via an equipment mount 16 and one or more components 15 which connect adjacent mounts 16. The bracket 31 comprises a central section 32 configured to be affixed to an equipment mount 16 which may have a plurality of attachment holes 34 configured to align with the components 15 which connect adjacent mounts 16. The bracket further comprises a plurality or mounting tabs 33 which are oriented perpendicular to the plane of the central section 32. The mounting tabs 33 may also extend laterally beyond the edge of the central section 32. The mounting tabs 33 preferably contain multiple mounting holes 36 which are configured to attach to a cable guide 10 via mounting fasteners 37. Bolts with nuts are the preferred mounting fasteners 37, but other fasteners known in the art may also be utilized.

The routing system 30 and its components are preferably made of metal unless specifically stated otherwise herein, though may be made of other rigid material.

Referring to the drawings FIG. 17, depicts the mounting system 30 with an attached cable guide 10 installed on an equipment mount 16. The routing system 30 further consists of one or more cable guides 10 which may be attached to the mounting tabs 33. Preferably, the bracket 12 of the cable guide will have holes bearing the same configuration of the mounting holes 36. In the preferred configuration, multiple holes on the bracket 12 would be aligned with mounting holes and mounting fasteners 37 would be utilized to attach the bracket holes to the mounting holes 36. Alternatively, the cable guide may be attached via a single bracket hole attached a single mounting hole 36 and mount fastener 37.

The cable guide 10 is configured such that it may be mounted to any mounting tab 33 and such that multiple cable guides 10 may be mounted to a single routing assembly 30.

Referring to the drawings, FIG. 17 depicts the routing system 30 assembled and attached to a communication tower. The clamp assembly 31 is preferably configured to be secured to two parallel components 15 of a communication tower and an equipment mount 16 affixed to a tower. To use the routing system 30, the bracket 31 is placed such that multiple attachment holes 34 are aligned with corresponding components 15 attached to the equipment mount 16. The components 15 are then placed through the attachment holes 34 and the bracket is moved along the components until it is in contact with an equipment mount 16. The components 15 are typically threaded rod, but may also comprise other connecting components known in the art. Once the bracket 31 is placed into contact with the equipment mount 16, attachment collars 35 are placed on the components 15 such that they hold the bracket firmly against the equipment mount. The attachment collars 35 are preferably threaded nuts which will engage with the components 15. However, the attachment collars 35 may also engage the components 15 via friction, permanent attachment, or other means of engagement known in the art. The cable guide may be attached to the clamp assembly as described hereinabove.

Once the assembly is mounted to the tower, a safety cable 14 may be inserted into the prongs 11 of the cable guide and may be secured by the lock 13 to ensure retention of the cable 14 by the cable guide 10. It may be desirable to install multiple assemblies to a single tower in various configurations.

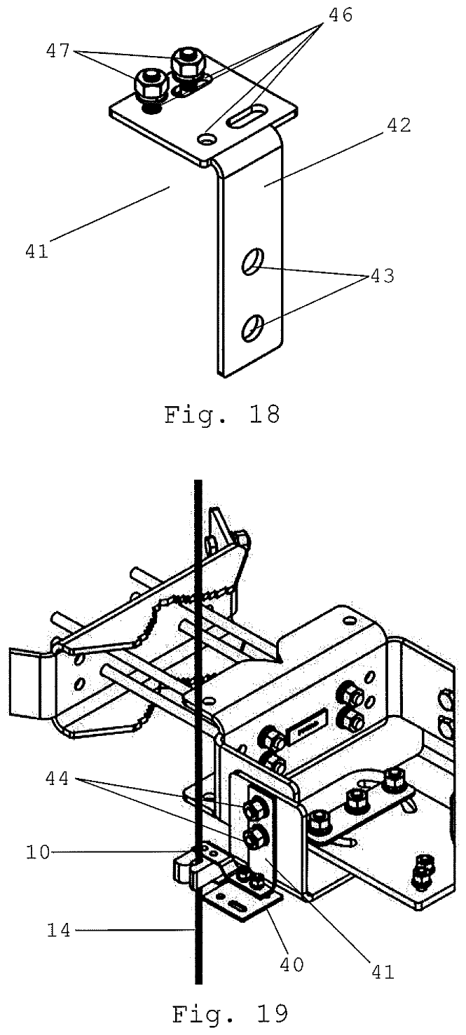

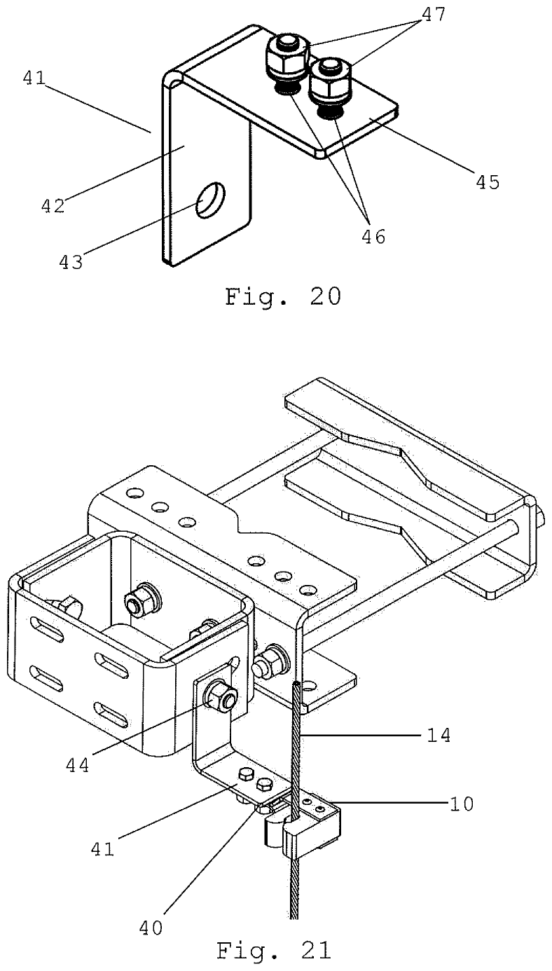

Referring to the drawings, FIGS. 18-21 depict a fourth embodiment of a safety cable routing system 40 featuring a mounting bracket 41 which comprises an attachment tab 42, one or more mounting tabs 45, attachment fasteners 44, and mounting fasteners 47.

The bracket 41 is configured to attach to a communication tower via an equipment mount 16. The bracket 41 comprises an attachment tab 42 configured to be affixed to an equipment mount 16 and may have one or more attachment holes 43 configured to align with holes in equipment mounts 16 The bracket 41 further comprises a plurality or mounting tabs 45 which are oriented perpendicular to the plane of the attachment tab 42. The mounting tabs 45 may also extend laterally beyond the edge of the attachment tab 42. The mounting tabs 45 preferably contain multiple mounting holes 46 which are configured to attach to a cable guide 10 via mounting fasteners 47. Bolts with nuts are the preferred mounting fasteners 47, but other fasteners known in the art may also be utilized.

The routing system 40 and its components are preferably made of metal unless specifically stated otherwise herein, though may be made of other rigid material.

Referring to the drawings FIGS. 19 and 21, depict the mounting system 40 with an attached cable guide 10 installed on an equipment mount 16. The routing system 40 further consists of one or more cable guides 10 which may be attached to the mounting tabs 45. Preferably, the bracket 12 of the cable guide will have holes bearing the same configuration of the mounting holes 46. In the preferred configuration, multiple holes on the bracket 12 would be aligned with mounting holes and mounting fasteners 47 would be utilized to attach the bracket holes to the mounting holes 46. Alternatively, the cable guide may be attached via a single bracket hole attached a single mounting hole 46 and mount fastener 47.

The cable guide 10 is configured such that it may be mounted to any mounting tab 45 and such that multiple cable guides 10 may be mounted to a single routing assembly 30.

Referring to the drawings, FIGS. 19 and 21 depict the routing assembly 40 assembled and attached to a communication tower component mount 16. To use the routing assembly 40, the bracket 41 is preferably placed in contact with a surface of a component mount 16 such that one or more attachment holes 43 are aligned with holes the equipment mount 16. Once the bracket 41 is placed into contact with the equipment mount 16, attachment fasteners 44 are used to attach the bracket 41 to the mount 16. Bolts with nuts are the preferred attachment fasteners 44, but other fasteners known in the art may also be utilized.

The cable guide may be attached to the clamp assembly as described hereinabove.

Once the assembly is mounted to the tower, a safety cable 14 may be inserted into the prongs 11 of the cable guide and may be secured by the lock 13 to ensure retention of the cable 14 by the cable guide 10. It may be desirable to install multiple assemblies to a single tower in various configurations.

What is claimed is:

1. A cable routing system comprising:
a clamp assembly comprising:
a plurality of clamp members comprising a plurality of center sections, a seating notch, and one or more mounting tabs;
a plurality of clamp rods and clamp collars configured to connect multiple clamp members; and
a cable guide configured to be attached to one of the mounting tabs of one of the clamp members comprising a bracket, a plurality of prongs configured to physically engage a safety cable.

2. The cable routing system as defined in claim 1 wherein the cable guide further comprises, a lock configured to inhibit the cable from disengaging from the prongs.

3. A cable routing system comprising:
a clamp assembly comprising:
a head piece comprising a plurality of hooks and a center section with a clamp hole and a mounting hole;
a tail piece having a J shape configured to be attached to the head piece;
a tail collar; and
a cable guide configured to be attached to the center section of the headpiece comprising a bracket, and a plurality of prongs configured to physically engage a safety cable.

4. The cable routing system as defined in claim 3 wherein the cable guide further comprises, a lock configured to inhibit the cable from disengaging from the prongs.

5. A cable routing system comprising:
a bracket configured to be attached to a communication tower equipment mount comprising a central section and a plurality of mounting tabs; and
a cable guide configured to be attached to a mounting tab comprising a bracket, and a plurality of prongs configured to physically engage a safety cable.

6. The cable routing system as defined in claim 5 wherein the cable guide further comprises, a lock configured to inhibit the cable from disengaging from the prongs.

7. A cable routing system comprising:
a bracket configured to be attached to a communication tower equipment mount comprising an attachment tab and a mounting tab; and
a cable guide configured to be attached to the mounting tab comprising a bracket, and
a plurality of prongs configured to physically engage a safety cable.

8. The cable routing system as defined in claim 7 wherein the cable guide further comprises, a lock configured to inhibit the cable from disengaging from the prongs.

9. A cable routing system comprising:
a clamp assembly and
a cable guide configured to be attached to the clamp assembly comprising a bracket, and a plurality of prongs configured to physically engage a safety cable.
